(19) United States
(12) Patent Application Publication
(10) Pub. No.: US 2022/0124021 A1
(43) Pub. Date: Apr. 21, 2022

(54) REACHABILITY MATRIX FOR NETWORK VERIFICATION SYSTEM

(71) Applicant: Huawei Technologies Co., Ltd., Shenzhen (CN)

(72) Inventors: Yan Sun, Santa Clara, CA (US); Wei Xu, Dublin, CA (US)

(21) Appl. No.: 17/646,336

(22) Filed: Dec. 29, 2021

Related U.S. Application Data
(63) Continuation of application No. PCT/US2019/040829, filed on Jul. 8, 2019.

(51) Int. Cl. H04L 45/02; H04L 49/101; H04L 45/745

(52) U.S. Cl. CPC H04L 45/02; H04L 45/745; H04L 49/101

(57) ABSTRACT

A network verification system processes a network forwarding state into atomic predicates and compresses a network routing table into an atomic predicates indexes set. A transitive closure among all pairs of nodes in the network is calculated from the atomic predicates and atomic predicates indexes set to generate an all-pair reachability matrix Mₙ of the network. A reachability report for the network is recursively generated for respective nodes based on the all-pair reachability matrix. The reachability report is used to dynamically program the network.

### CROSS-REFERENCE TO RELATED APPLICATIONS

This application is a continuation of International Application No. PCT/US2019/040829, filed on Jul. 8, 2019, entitled “REACHABILITY MATRIX FOR NETWORK VERIFICATION SYSTEM,” the benefit of priority of which is claimed herein, and which application is hereby incorporated herein by reference in its entirety.

### TECHNICAL FIELD

This application is directed to a network verification system for verifying a network in real-time and, more particularly, to systems and methods of verifying end-to-end reachability between nodes.

### BACKGROUND

Switches and routers generally operate by indexing into a forwarding table using a destination address and deciding where to send a received packet. In recent years, such forwarding has grown more complicated. New protocols for specific domains, such as data centers, wide area networks (WANs) and wireless, have greatly increased the complexity of packet forwarding. This complexity makes it increasingly difficult to operate a large network. Complexity also makes networks fragile and susceptible to problems where hosts become isolated and unable to communicate. Moreover, debugging reachability problems is very time consuming. Even simple questions such as “Can Host A talk to Host B?” or “Can packets loop in my network?” or “Can User A listen to communications between Users B and C?” are difficult to answer. These questions are especially hard to answer in networks carrying multiple encapsulations and containing boxes that filter packets.

Network state may change rapidly in response to customer demands, load conditions or configuration changes. But the network must also ensure correctness conditions, such as isolating tenants from each other and from critical services. Existing policy checkers cannot verify compliance in real-time because of the need to collect state information from the entire network and the time it takes to analyze this state.

Existing network verification or analysis methods mainly focus on single point analysis and verification. Few network verification or analysis methods evaluate the network as a whole and provide an overall review function. Those network verification or analysis methods that provide whole network analysis functionality do so by traversing all possible node pairs or paths and verifying them one by one, which costs lots of time and space.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

An automatic network review tool is provided that takes the network's forwarding state as input, summarizes the overall state, and generates reports about the reachability relationship, the key nodes through which packets must travel, the duplicated routes, or back-up routes of the network. Also, when network operators need to switch the configuration of a network into a new configuration, a general difference report of the old and new configurations is desirable for facilitating the configuration changes. The network analyzing tool described herein addresses this need while further strengthening the operator's capability to better administer the network.

The network review tool described herein may analyze the all-pair reachability relationship between nodes in a network from the existing forwarding plane. The network review tool quickly calculates the all-pair reachability relationship of a network so as to give the network operator an overall picture of the real function of the network. The network review tool also finds all possible paths between nodes, thus enabling the operator to locate duplicated routes, ensure back-up routes, and pin-point key nodes. These functions are realized by pre-processing the network forwarding state (routing information base (RIB) or forwarding information base (FIB)) into atomic predicates using an algorithm from AP-Verifier or Veriflow or other algorithms to generate atoms in header space and then to compress the routing table into an atomic predicate indexes set that reduces the number and the complexity of the routing table. As used herein, each atomic predicate in a real network represents a very large number of equivalent packets in many disjoint fragments of the packet space. The network review tool may compute reachability trees for the atomic predicates where each reachability tree represents a very large number of packets with equivalent behavior, rather than the behavior of individual packets. The use of atomic predicates thus reduces the time and space required for computing and storing the reachability trees, as well as for verifying reachability properties, by orders of magnitude.

In sample embodiments, the entire network routing table is modeled into a routing matrix by adopting a method inspired by the Warshall all-pair reachability algorithm to calculate all-pair reachability of the network and to record the path history while calculating the all-pair reachability for further analysis. A reachability report and network property (key point, black hole, loop, duplicated routes and backup routes) report is generated based on the calculation result. The described network review tool can be implemented via software that is executed by one or more processors in a data center or cloud-like public cloud, private cloud or hybrid cloud.

A first aspect of the present disclosure relates to a network verification system comprising a non-transitory memory storing instructions and at least one processor in communication with the memory, the at least one processor configured, upon execution of the instructions, to perform the following steps: process a network forwarding state into atomic predicates and compress a network routing table into an atomic predicates indexes set. A transitive closure among all pairs of nodes in the network is calculated from the atomic predicates and atomic predicates indexes set to generate an all-pair reachability matrix Mₙ of the network. A reachability report for the network is recursively generated for respective nodes based on the all-pair reachability matrix Mₙ of the network, and the network is dynamically programmed using the reachability report.

In a first implementation according to the first aspect as such, the at least one processor further executes the instructions to calculate the transitive closure among all pairs of nodes in the network by modeling a network routing table into a routing matrix comprising the all-pair reachability matrix Mₙ.

In a second implementation according to the first aspect or any preceding implementation of the first aspect, the at least one processor further executes the instructions to calculate the all-pair reachability matrix Mₙ by calculating for each pair of nodes in the network, whether there is any packet that may travel from one node to another node of the pair of nodes, and collecting packet headers from all possible paths between the pair of nodes.

In a third implementation according to the first aspect or any preceding implementation of the first aspect, an element R^{k}ᵢⱼ in the all-pair reachability matrix Mₙ includes a reachability packet space set between node i and node j, where k is an intermediate node, further comprising the at least one processor executing the instructions to calculate the element R^{k}ᵢⱼ as:

R^{k}[i,j]=R^{k-1}[i,j]∪(R^{k-1}[i,k]∩R^{k-1}[k,j]).

In a fourth implementation according to the first aspect or any preceding implementation of the first aspect, the at least one processor further executes the instructions to identify a loop in the network when any element on a diagonal of the all-pair reachability matrix Mₙ is not an empty set.

In a fifth implementation according to the first aspect or any preceding implementation of the first aspect, the at least one processor further executes the instructions to identify a black hole in the network when all elements in a row of the all-pair reachability matrix Mₙ comprise an empty set.

In a sixth implementation according to the first aspect or any preceding implementation of the first aspect, the at least one processor further executes the instructions to update the calculated all-pair reachability matrix Mₙ by recalculating only elements affected by an update.

In a seventh implementation according to the first aspect or any preceding implementation of the first aspect, the at least one processor further executes the instructions to calculate the all-pair reachability matrix Mₙ without performing a reachability matrix calculation for non-intermediate nodes in the network.

In an eighth implementation according to the first aspect or any preceding implementation of the first aspect, the at least one processor further executes the instructions to calculate the all-pair reachability matrix Mₙ by performing the reachability matrix calculation for first nodes with frequent updates after performing the reachability matrix calculation for second nodes without frequent updates.

In a ninth implementation according to the first aspect or any preceding implementation of the first aspect, the at least one processor further executes the instructions to calculate the all-pair reachability matrix Mₙ based on matrices of nodes.

A second aspect of the present disclosure relates to a computer implemented method of verifying a state of a network comprising a plurality of nodes. The method includes processing a network forwarding state into atomic predicates, compressing a network routing table into an atomic predicates indexes set, calculating a transitive closure among all pairs of nodes in the network from the atomic predicates and atomic predicates indexes set to generate an all-pair reachability matrix Mₙ of the network, recursively generating for respective nodes a reachability report for the network based on the all-pair reachability matrix Mₙ of the network, and dynamically programming the network using the reachability report.

In a first implementation according to the second aspect as such, calculating the transitive closure among all pairs of nodes in the network comprises modeling a network routing table into a routing matrix comprising the all-pair reachability matrix Mₙ.

In a second implementation according to the second aspect or any preceding implementation of the second aspect, calculating the all-pair reachability matrix Mₙ comprises calculating, for each pair of nodes in the network, whether there is any packet that may travel from one node to another node of the pair of nodes, and collecting packet headers from all possible paths between the pair of nodes.

In a third implementation according to the second aspect or any preceding implementation of the second aspect, an element R^{k}ᵢⱼ in the all-pair reachability matrix Mₙ includes a reachability packet space set between node i and node j where k is an intermediate node, further comprising calculating the element R^{k}ᵢⱼ as:

R^{k}[i,j]=R^{k-1}[i,j]∪(R^{k-1}[i,k]∩R^{k-1}[k,j]).

In a fourth implementation according to the second aspect or any preceding implementation of the second aspect, the method further comprises identifying a loop in the network when any element on a diagonal of the all-pair reachability matrix Mₙ is not an empty set.

In a fifth implementation according to the second aspect or any preceding implementation of the second aspect, the method further comprises identifying a black hole in the network when all elements in a row of the all-pair reachability matrix Mₙ comprise an empty set.

In a sixth implementation according to the second aspect or any preceding implementation of the second aspect, the method further comprises updating the all-pair reachability matrix Mₙ by recalculating only elements affected by an update.

In a seventh implementation according to the second aspect or any preceding implementation of the second aspect, calculating the all-pair reachability matrix Mₙ comprises calculating the all-pair reachability matrix Mₙ without performing a reachability matrix calculation for non-intermediate nodes in the network.

In an eighth implementation according to the second aspect or any preceding implementation of the second aspect, calculating the all-pair reachability matrix Mₙ comprises performing the reachability matrix calculation for first nodes with frequent updates after performing the reachability matrix calculation for second nodes without frequent updates.

In a ninth implementation according to the second aspect or any preceding implementation of the second aspect, calculating the all-pair reachability matrix Mₙ comprises calculating the all-pair reachability matrix Mₙ based on matrices of nodes.

A third aspect of the present disclosure relates to a non-transitory computer-readable medium storing computer instructions for implementing verification of a state of a network comprising a plurality of nodes, that when executed by at least one processor, causes the at least one processor to perform the steps of processing a network forwarding state into atomic predicates, compressing a network routing table into an atomic predicates indexes set, calculating a transitive closure among all pairs of nodes in the network from the atomic predicates and atomic predicates indexes set to generate an all-pair reachability matrix Mₙ of the network, recursively generating for respective nodes a reachability report for the network based on the all-pair reachability matrix Mₙ, and dynamically programming the network using the reachability report.

In a first implementation according to the third aspect as such, the medium further comprises instructions that, when executed by the at least one processor, cause the at least one processor to calculate the transitive closure among all pairs of nodes in the network by modeling a network routing table into a routing matrix comprising the all-pair reachability matrix Mₙ.

In a second implementation according to the third aspect or any preceding implementation of the third aspect, the medium further comprises instructions that, when executed by the at least one processor, cause the at least one processor to calculate the all-pair reachability matrix Mₙ by calculating, for each pair of nodes in the network, whether there is any packet that may travel from one node to another node of the pair of nodes, and collecting packet headers from all possible paths between the pair of nodes.

In a third implementation according to the third aspect or any preceding implementation of the third aspect, an element R^{k}ᵢⱼ in the all-pair reachability matrix Mₙ includes a reachability packet space set between node i and node j, where k is an intermediate node, and the medium further comprises instructions that, when executed by the at least one processor, cause the at least one processor to calculate the element R^{k}ij as:

R^{k}[i,j]=R^{k-1}[i,j]∪(R^{k-1}[i,k]∩R^{k-1}[k,j]).

In a fourth implementation according to the third aspect or any preceding implementation of the third aspect, the medium further comprises instructions that, when executed by the at least one processor, cause the at least one processor to identify a loop in the network when any element on a diagonal of the all-pair reachability matrix Mₙ is not an empty set.

In a fifth implementation according to the third aspect or any preceding implementation of the third aspect, the medium further comprises instructions that, when executed by the at least one processor, cause the at least one processor to identify a black hole in the network when all elements in a row of the all-pair reachability matrix Mₙ comprise an empty set.

In a sixth implementation according to the third aspect or any preceding implementation of the third aspect, the medium further comprises instructions that, when executed by the at least one processor, cause the at least one processor to update the all-pair reachability matrix Mₙ by recalculating only elements affected by an update.

In a seventh implementation according to the third aspect or any preceding implementation of the third aspect, the medium further comprises instructions that, when executed by the at least one processor, cause the at least one processor to calculate the all-pair reachability matrix Mₙ without performing a reachability matrix calculation for non-intermediate nodes in the network.

In an eighth implementation according to the third aspect or any preceding implementation of the third aspect, the medium further comprises instructions that, when executed by the at least one processor, cause the at least one processor to calculate the all-pair reachability matrix Mₙ by performing the reachability matrix calculation for first nodes with frequent updates after performing the reachability matrix calculation for second nodes without frequent updates.

In a ninth implementation according to the third aspect or any preceding implementation of the third aspect, the medium further comprises instructions that, when executed by the at least one processor, cause the at least one processor to calculate the all-pair reachability matrix Mₙ by calculating the all-pair reachability matrix Mₙ based on matrices of nodes.

The methods described herein can be performed and the instructions on computer readable media may be processed by the apparatus, and further features of the method and instructions on the computer readable media result from the functionality of the apparatus. Also, the explanations provided for each aspect and its implementation apply equally to the other aspects and the corresponding implementations. The different embodiments may be implemented in hardware, software, or any combination thereof. Also, any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates the overall architecture of a sample data-plane network verification system of a sample embodiment.

FIG. 2 illustrates the input/output modules of the network verification system of FIG. 1.

FIG. 3 illustrates calculating all-pair reachability matrices in a sample embodiment.

FIG. 4 illustrates an incremental update example for the all-pair reachability matrices calculated in FIG. 3.

FIG. 5 illustrates an example where a non-intermediate node in the simple network of FIG. 3 does not need to be calculated.

FIG. 6 illustrates the overall trie-based data-plane verification architecture of a sample packet network.

FIG. 7 illustrates reachability trees generated by a reachability tree generator for each port of each network device in a sample embodiment.

FIG. 8 illustrates a method for verifying a network state in an example embodiment.

FIG. 9 illustrates a network unit in an example embodiment.

FIG. 10 illustrates a network component suitable for implementing one or more embodiments of the network unit processing elements.

### DETAILED DESCRIPTION

This application is directed to a network verification system for verifying a network in real-time and, more particularly, to systems and methods of verifying end-to-end reachability between nodes to provide fast verification for different kinds of networks and to calculate all-pair reachability in a network that enables matrix-based dynamic programming.

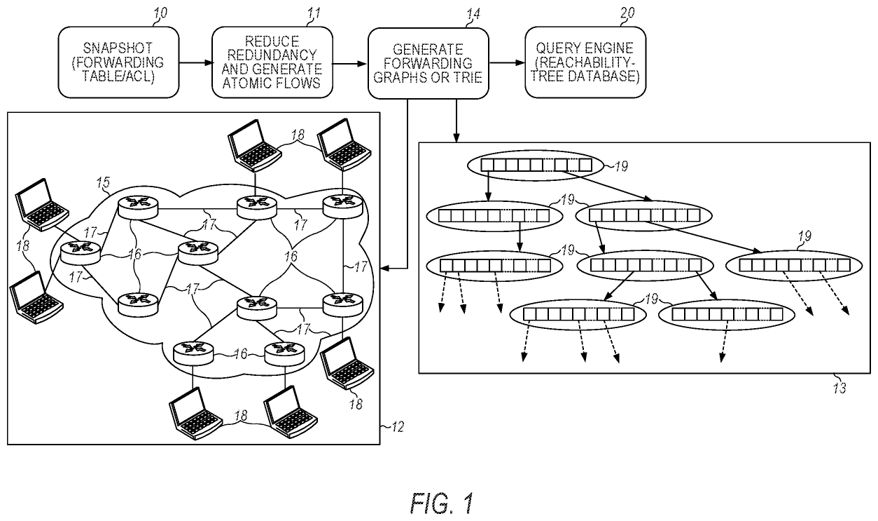

In the following description, reference is made to the accompanying FIGS. 1-10 that form a part hereof, and in which is shown by way of illustration specific embodiments which may be practiced. These embodiments are described in sufficient detail to enable those skilled in the art to practice the disclosure, and it is to be understood that other embodiments may be utilized, and that structural, logical and electrical changes may be made without departing from the scope of the present disclosure. The following description of example embodiments is, therefore, not to be taken in a limited sense, and the scope of the present disclosure is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

### Overview

In graph theory, reachability refers to the ability to get from one vertex to another within a graph. A vertex s can reach a vertex t (and t is reachable from s) if there exists a sequence of adjacent vertices (i.e. a path) that starts with s and ends with t. In an undirected graph, reachability between all pairs of vertices can be determined by identifying the connected components of the graph. Any pair of vertices in such a graph can reach each other if and only if they belong to the same connected component. The All-Pair Reachability calculation notes that if there are N nodes in the topology/graph, there are N² pairs, where N is very large and increasing fast. Existing approaches to all-pair reachability calculations use brute force methods that are very slow because of recalculation, which makes real-time network verification virtually impossible.

For a directed graph G=(V, E), with vertex set V and edge set E, the reachability relation of G is the transitive closure of E in that the set of all ordered pairs (s, r) of vertices in V for which there exists a sequence of vertices v₀=s, v₁, v₂, . . . , vₖ=t such that the edge (vᵢ₋₁, vᵢ) is in E for all 1≤i≤k. If G is acyclic, then its reachability relation is a partial order defined as the reachability relation of its transitive reduction. Since partial orders are anti-symmetric, ifs can reach t, then it is known that t cannot reach s. On the other hand, if a packet could travel from s to t and back to s, then G would contain a cycle, contradicting that it is acyclic. If G is directed but not acyclic (i.e., it contains at least one cycle), then its reachability relation will correspond to a preorder instead of a partial order.

While conventional approaches use brute force methods to generate reachability trees for each node, the methodology described herein instead focuses on all-pair reachability generation between nodes in the network from the existing forwarding plane to replace the reachability tree generation. The methodology verifies all-pair reachability and also provides loop detection, isolation detection, black hole detection, and the like. To calculate the all-pair reachability relationship of a network, the system determines for each pair of nodes in the network whether there is a packet that can travel from one node to the other. If such a packet exists, the full set of the packet header is evaluated. In sample embodiments, this is done by traversing the network from each node, ejecting all-wildcard packets at that node, looking up the routing table along the way to reduce packet header set, and collecting all packet header from all possible paths.

### Network Verification System

An efficient network verification system and method verifies even complicated networks in real-time by providing an efficient data structure to store network policies and algorithms to process flows. Data plane verification is used because the data plane is closely tied to the network's actual behavior, so that it can catch bugs that other tools miss. For example, configuration analysis cannot find bugs that occur in router software. Also, the data plane state has relatively simple formats and semantics that are common across many higher-layer protocols and implementations, thus simplifying rigorous analysis of a network. With a goal of real-time verification, the data plane state is processed in sample embodiments to verify network status such as:

Reachability

Loop Detection

Isolation

Black holes

Waypoint

Consistency

Link up/down

The methods described herein improve the efficiency of data plane data structures by focusing on all-pair reachability generation to replace reachability tree generation and pre-computing a compressed representation of the relevant header spaces instead of relying upon “run-time” compression. The common overall data-plane network verification architecture is illustrated in FIG. 1. As illustrated in FIG. 1, the network verification system at block 10 forwards a snapshot of the state of the network at a point in time. In sample embodiments, the snapshot includes a copy of the forwarding table and access control list (ACL) at the point in time. The network verification system and method then at block 11 reduces any redundancies and generates atomic flows for the identified equivalence classes (ECs). The network verification system and method then generates forwarding graph 12 or trie 13 at block 14. The figure shows a forwarding graph 12 or trie 13 that represent a network or network portion 15. The forwarding graph 12 includes network nodes 16 and links 17 between nodes 17. User devices 18 can connect to nodes 16 and exchange communications and/or data with the network 15 via the nodes 16 and links 17. The forwarding trie 13 shows the relationships of the respective leaves 19 in the network 15 where the position in the tree 13 defines the nodes with which a given node is associated. The network verification system may also generate a compact port-based forwarding graph that stores the rules and generates less atomic flows to enable faster incremental verification, instead of recalculation, while using less memory. The network verification system at block 20 further enables an operator to query the status of the network using a query from a query engine.

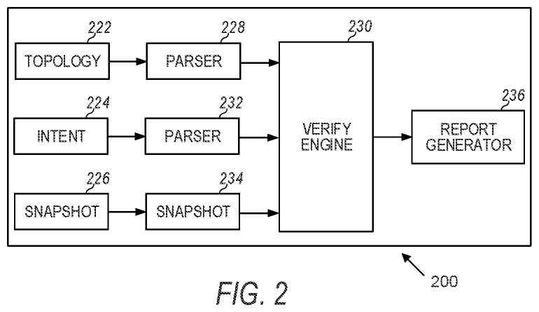

The input/output modules of a network verification system 200 of FIG. 1 are shown in FIG. 2 according to an embodiment. As illustrated, the network operator specifies the topology 222 of the network, the intent 224 of the network verification (e.g., what to check for), and the snapshot policy 226 specifying the forwarding state information. The topology 222 is parsed by topology parser 228 and provided to the verify engine 230. Similarly, the intent 224 is parsed by intent parser 232, the snapshot policy 226 is parsed by the snapshot parser 234, and the parsed intent and snapshot data is also provided to the verify engine 230. The verify engine 230 provides calculated verification data to report generator 236 to generate a network status report for the operator.

In the network verification of FIG. 1, the bottleneck is the all-pair reachability calculation. As noted above, if there are N nodes in the topology/graph, there are N² pairs, where N is very large and increasing fast. To achieve real-time verification, the system described herein creates a reachability matrix that is used to calculate transitive closure. The resulting reachability report is then used to dynamically program the network using, for example, timing complexity O(n³) and a limited intermediate node algorithm. The advantages of such an approach is that it is fast in that no recalculation is required, the matrix records all information between two nodes and establishes a path history, loops and black holes may be detected very rapidly, fast incremental updates are possible, and the system is scalable using divide-and-conquer techniques.

### All-Pair Reachability

In some embodiments, a network review tool is provided to analyze the all-pair reachability relationship between nodes in the network from the existing forwarding plane. The network review tool provides a reachability matrix to calculate transitive closure (i.e., the set of all places that may be accessed from a starting place). The network review tool quickly calculates the all-pair reachability relationship of a network and gives the network operator an overall picture of the real function of the network. The network review tool also finds all current possible paths between nodes, thus enabling the operator to locate duplicated routes, ensure back-up routes, and to pin-point key nodes.

One atom is a piece of N-dimension header space representing a set of packets whereby all packets that belong to the same atom have the same behavior in the whole network. Forwarding tables and access control lists (ACLs) are packet filters that can be parsed and represented by predicates that guard input and output ports of intermediate network nodes. The variables of such a port predicate are packet header fields. Given a set P of predicates, its set of atomic predicates {p₁, . . . , pₖ} satisfies the following properties:

1) pᵢ≠false, ∀i∈{1, . . . , k}.

2) V^{k}ᵢ₌₁ pᵢ=true.

3) pᵢ∧pⱼ=false, if i≠j.

4) Each predicate P∈P, P≠false, is equal to the disjunction of a subset of atomic predicates:

P=V_{iϵS(P)} pi, where S(P)⊆{1, . . . , k}.

5) k is the minimum number such that the set {p₁, . . . , pₖ} satisfies the above four properties.

Given a set P, there are numerous sets of predicates that satisfy the first four properties. In the trivial case, these four properties are satisfied by the set of predicates, each of which specifies a single packet. The set with the smallest number of predicates is the atomic predicate. In particular, for a given set P of predicates, the set of atomic predicates for P specifies the minimum set of equivalence classes in the set of all packets. Atoms in header space are the same as an atomic predicate. All atoms/atomic predicates in the packet header space, and every point in the header space, represent a packet header. Packet headers in the same atom/atomic predicate have exactly the same behavior/result/action in the whole network. Each atomic predicate has a unique index, and an atomic predicate indexed set is used to present a set of atomic predicates.

The system pre-processes the network forwarding state (RIB, FIB) into atomic predicates using, for example, an algorithm from AP-Verifier or Veriflow or other algorithms to generate atoms in header space and to compress the routing table into an atomic predicate indexed set that reduces the number and the complexity of the routing table. For example, a typical packet header for a typical network may have 200 bits and thus 2²⁰⁰ possible values, which is too many. This is why atoms are used. For example, if there are two rules that divide the possible header values (header space) into two parts (atoms), only two atoms may be used as an index to represent all possible header space. Usually, the number of atoms generated is between hundreds to thousands, and one atom may represent a large number of values (e.g., 2¹⁹⁹). The atomic predicate indexed set thus reduces the number to 100-1000 indices. The whole network routing table is then modeled into a routing matrix by adopting a method inspired by the Warshall all-pair reachability algorithm to calculate all-pair reachability of the network and to record during the calculation the path history for further analysis. A reachability report and network property (key point, black hole, loop, duplicated routes and backup routes) report is generated based on the calculation result. In this context, a node is a key point if reachability from node A to node B must go through that node (key point), which is a special reachability case. For example, all incoming traffic into a network from outside the network may be required to pass through a firewall, which would be a key point for the network.

For example, those skilled in the art will appreciate that the Floyd-Warshall algorithm is an algorithm for finding shortest paths in a weighted graph with positive or negative edge weights. A single execution of the algorithm will find the lengths of shortest paths between all pairs of vertices. Although it does not return details of the paths themselves, it is possible to reconstruct the paths with simple modifications to the algorithm. Versions of the algorithm can also be used for finding the transitive closure of a relation or the widest paths between all pairs of vertices in a weighted graph. In sample embodiments, the Floyd-Warshall algorithm can be used to compute the transitive closure of any directed graph, which gives rise to the reachability relation as described herein.

In sample embodiments, a series of matrices are calculated to get the final all-pair reachability matrix. For nodes in the network numbered 1, 2, . . . , n, element R^{k}ᵢⱼ in matrix Mₖ means the reachability packet space set between node i and node j that uses intermediate nodes numbered with 1, 2, . . . , k that define a final all-pair reachability matrix Mₙ. Matrix M₀ is the adjacency matrix of the network (no intermediate nodes). Mₙ is calculated in a recursive way as follows:

R^{k}[i,j]=R^{k-1}[i,j]∪(R^{k-1}[i,k]∩R^{k-1}[k,j]) (1)

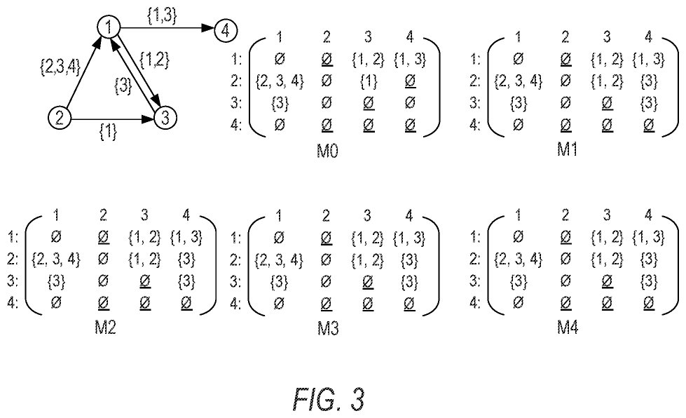

FIG. 3 illustrates calculating all-pair reachability matrices in a sample embodiment. In this simple example, four nodes (1)-(4) share packets 1-4 as illustrated. For example, node (1) receives packets {2, 3, 4} from node (2) and packet {3} from node (3) and provides packets {1, 2} to node (3) and packets {1, 3} to node (4). Node (2) provides packets {2, 3, 4} to node (1) and packet {1} to node (3) but does not receive packets from any of the other nodes. Node (3) provides packet {3} to node (1) and receives packet (1) from node (2) and packets {1, 2} from node (1). Finally, node (4) receives packets {1, 3} from node (1) and provides no packets to any other node.

Reachability matrix M₀ illustrates the communication of packets from adjacent nodes without consideration of any intermediate nodes. An empty set indicates that them is no direct communication between the indicated nodes in the matrix.

Reachability matrix M₁ modifies the matrix M₀ to further illustrate the communication of packets through node (1) as an intermediate node. In this example, packet {2} is further communicated from node (2) to node (3) via node (1) and packet {3} is further communicated from node (2) to node (4) via node (1). Also, packet {3} is further communicated from node (3) to node (4) via node (1).

Reachability matrix M₂ illustrates the communication of packets through node (2) as an intermediate node. Since node (2) cannot be an intermediate node, the reachability matrix M₂ is the same as reachability matrix M₁. Similarly, as nodes (3) and (4) do not function as intermediate nodes, reachability matrices M₃ and M₄ are similarly unchanged.

Advantages of developing the all-pair reachability matrix in this manner is that the resulting reachability matrix may be used to identify if loops or black holes exist in the network. For example, a loop is detected if any element on the diagonal of the matrices is not an empty set ϕ (i.e., a packet may loop back to the originating node). Also, a black hole may be identified from the resulting all-pair reachability matrix if Mₙ has a row whose elements are all empty sets. For example, in the example of FIG. 3, node (4) is a black hole.

It will be appreciated that the reachability matrix Mₙ records all information between two nodes and that no recalculation is needed. The resulting system thus maintains a path history for the network.

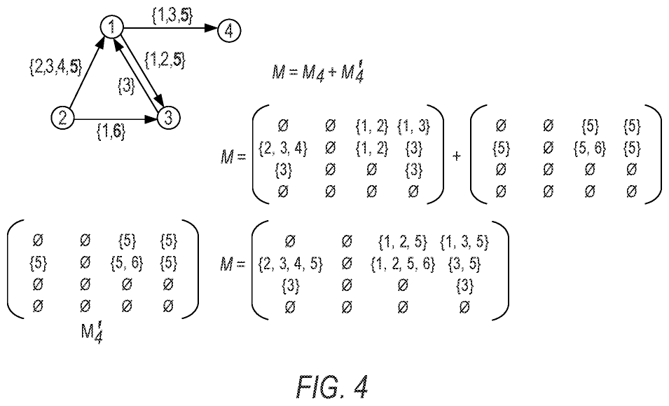

The reachability matrix Mₙ also provides fast incremental updates. For example, FIG. 4 illustrates an incremental update example for the all-pair reachability matrices calculated in FIG. 3. In the example of FIG. 4, the network for FIG. 3 is updated to further communicate packet {5} from node (2) to node (1), from node (1) to node (4), and from node (1) to node (3). Also, node (2) further communicates packet (6) to node (3). The update matrix is represented as matrix M₄′, which includes node (1) as an intermediate node. As illustrated, the reachability matrix M for the entire network may be obtained by adding together the original reachability matrix M₄ and matrix M₄′ (e.g., M=M₄+M₄′) without further calculations. Thus, the updated reachability matrix M may be updated by only recalculating the affected elements, providing a simple incremental verification process.

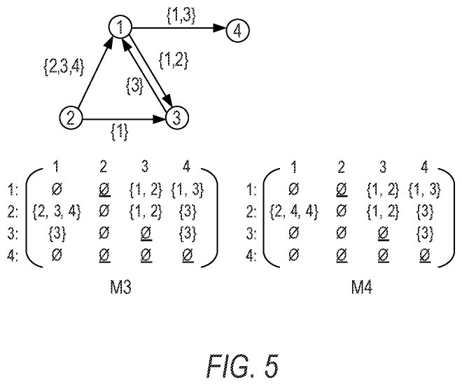

FIG. 5 illustrates an example where a non-intermediate node in the simple network of FIG. 3 does not need to be calculated. In this example, the node 4 is not an intermediate node, so there is no need to calculate matrix M₄ or to keep information for matrix M₄. M₄ is the same as M₃. M₃ needs to be calculated, but there is no new atom to be added. Also, node 2 is not an intermediate node, so reachability matrix M₂ is the same as M₁ and need not be calculated either. In real network topology, most nodes are not intermediate nodes, so recognizing that a node is not an intermediate node may be used to significantly reduce computation and storage for the reachability matrix.

As another optimization, the computation sequence of the nodes for determining the reachability matrix may be modified to calculate the reachability matrix for nodes with frequent updates last so that the reachability matrices processed before the updated reachability matrices will not be affected during updates.

As yet another optimization, some calculations can be based on matrices as opposed to a graph. For example, if node A to node B is an empty set ϕ. A cannot reach any node through B. In other words, if (A to B) n (B to C) is an empty set, no update from A to C is needed in the reachability matrix.

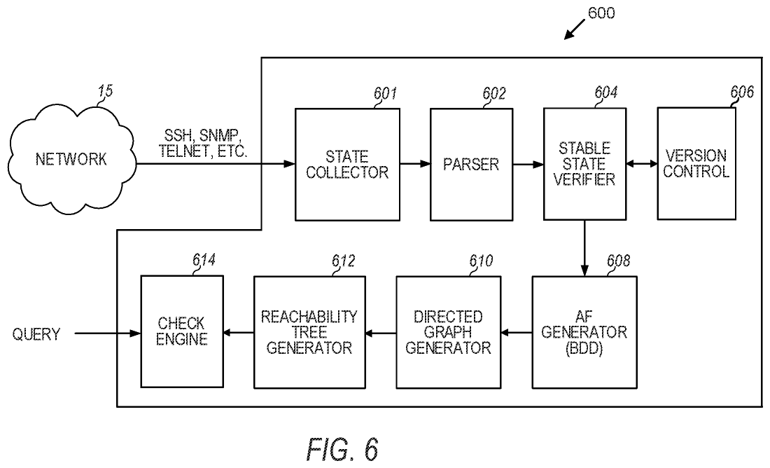

In sample embodiments, each atomic flow through the network is a BDD (Binary Decision Diagram) covering a disjoint set. For incremental verification, a BDD operation is used. BDDs generates tries, which branch on one bit (or several bits) at a time. A packet network is modeled as a directed graph of boxes. For example. FIG. 6 illustrates the overall trie-based data-plane verification architecture of a sample packet network 15. The input data is collected from network devices of the network 15 using simple network management protocol (SNMP), secure shell (SSH) cryptographic network protocol, Telnet, and the like. A state collector 601 receives a network topology snapshot and collects state information from the snapshot. The state collector 601 also compares two continuous stable snapshots and sends the difference to a parser 602. The snapshot is parsed by parser 602, and the parsed information is verified by stable state verifier 604 that performs the functions of the verify engine 30 noted above with respect to FIG. 2. The output of the stable state verifier 604 is provided to version control device 606 to establish version control of the received information. The verified stable state information is also used by atomic flow (AF) generator (BDD) 608 to generate atomic flows that are subsequently provided to directed graph generator 610 by the AF generator 608 to generate directed graphs. The directed graphs generated by the directed graph generator 610 are provided to reachability tree generator 612 to generate reachability trees using the methods described above with respect to FIGS. 3-5. The directed graphs and reachability trees are provided to the check engine 614, which can be queried to generate reports regarding network status, as described above with respect to FIG. 2.

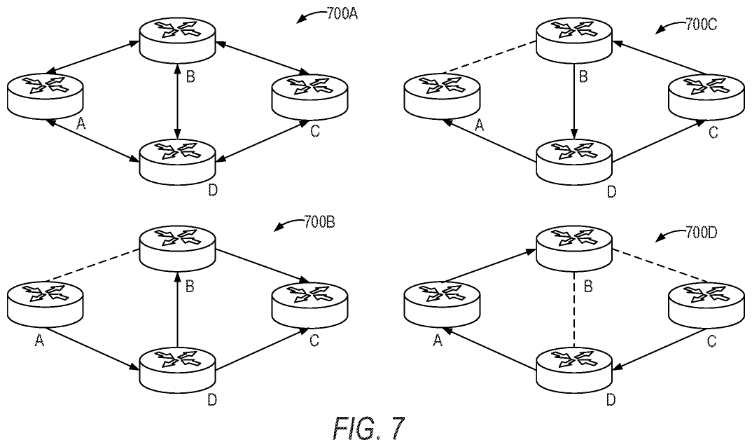

Queries to the check engine 614 relate to the status of the network 15. For example, the queries may include reachability, loop detection, isolation, and the like. By recognizing that reachability is fundamental, the techniques described herein may be used to combine the queries and to reuse reachability results whereby a reachability tree for each port may be built and stored as the trie is being built, thereby reducing the complexity of the network from O(N²) to O(N), where N is the number of ports. For example, a reachability tree may be generated by reachability tree generator 612 for each port of each network device 700 of network 15 (FIG. 1) as illustrated in FIG. 7. Reachability tree 700A shows the overall topology, while reachability trees 700B, 700C, and 700D show the reachability trees starting from nodes (ports) A, B, and C of reachability tree 700A, respectively. The ports A. B, and C of the reachability trees show that loop detection is based on the reachability tree for every port to find a loop, while isolation is also based on the reachability tree for every port. All ports, including inbound and outbound ports are calculated. For access ports, all input is considered, while for other ports, filtered input from a port-based Directed Dependency Graph is used.

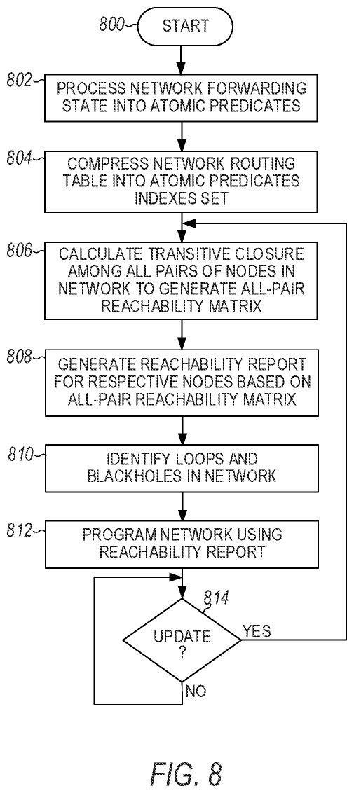

FIG. 8 illustrates a method for verifying a network state in an example embodiment. In particular, FIG. 8 illustrates the process performed by the network verification system described herein. As illustrated in FIG. 8, the process starts at 800 and processes the network forwarding state into atomic predicates at 802. The network routing table is compressed into an atomic predicates indexes set at 804. A transitive closure among all pairs of nodes in the network is calculated from the atomic predicates and atomic predicates indexes set to generate an all-pair reachability matrix of the network at 806. In sample embodiments, the transitive closure among all pairs of nodes in the network may be calculated by modeling the compressed network routing table into a routing matrix comprising the all-pair reachability matrix of the network. Also, the all-pair reachability matrix of the network may be calculated by calculating (for each pair of nodes in the network) whether there is any packet that may travel from one node to another node of the pair of nodes, and collecting packet headers from all possible paths between the pair of nodes. In the sample embodiments, this calculation includes calculating (or recursively calculating) elements R^{k}ᵢⱼ for inclusion in the all-pair reachability matrix Mₙ of the network having a reachability packet space set between node i and node j (where k is an intermediate node). An element can be generated using equation 1.) A reachability report for the network is recursively generated for respective nodes at 808 based on the calculated all-pair reachability of the network.

Loops and/or blackholes may optionally be identified at 810 to reduce unnecessary processing of nodes that do not contribute to the reachability of the network. For example, a loop in the network is identified when any element on a diagonal of the all-pair reachability matrix is not an empty set, and a black hole in the network is identified when all elements in a row of the all-pair reachability matrix comprise an empty set.

At 812, the generated reachability report is used to dynamically program the network. At 814, the process checks for updates to the calculated all-pair reachability matrix. If an update is identified, the process returns to step 806 to calculate the transitive closure among all pairs of updated nodes in the network to generate an updated all-pair reachability matrix. In sample embodiments, only elements affected by an update to the network need to be recalculated. Also, further efficiencies are gained by calculating the all-pair reachability matrix without performing a reachability matrix calculation for non-intermediate nodes in the network. Further efficiencies may be obtained by performing the reachability matrix calculation for nodes in the network with frequent updates after other nodes without frequent updates or by performing the reachability matrix calculation based on matrices of nodes instead of a network graph. Other optimizations will become apparent to those skilled in the art.

Those skilled in the art will further appreciate that the systems and methods described herein has many advantages over prior network verification systems. For example, the disclosed systems and methods enable interference-aware cluster management and enhanced parallel processing using multi-core processors as the reachability matrices may be calculated in parallel. It will be further appreciated that the disclosed methods are particularly beneficial in that they solve the all-pair reachability issue in networks without using brute force and use a reachability matrix to solve the reachability issue in the network verification process. The methods are fast in that most of the calculated results are reused and fast incremental calculation is used instead of recalculation. Also, reachability, loop detection, and isolation are easily verified at the same time within the matrix. The all-pair reachability matrix described herein also can provide a fast query about reachability between any two nodes, and is easy to implement for debugging purposes. The fast calculations also enable real-time checking and monitoring of the network status based on the network operator's intent. Those skilled in the art will further appreciate that the systems and methods described herein easily integrate with existing network verification systems for different kinds of networks and may be easily integrated with minimal efforts into cloud network management systems implementing existing cloud services like a public cloud, a private cloud, or a hybrid cloud.

Those skilled in the art will further appreciate that the systems and methods described herein solve a general graph theory question and optimize it based on the real cloud network structure, thereby minimizing costly network outages in cloud/data center. The systems and methods described herein also do not send traffic to the cloud network so, upon implementation, the systems and methods will not affect current network traffic.

### Network and Computer Architecture

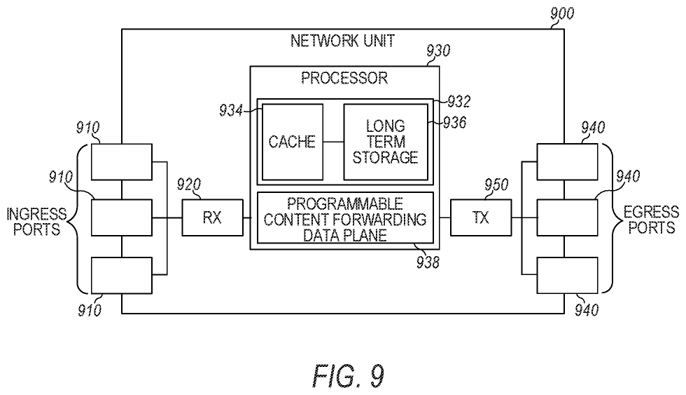

FIG. 9 illustrates an embodiment of a network unit 900, which may be any device that transports and processes data through a network such as the sample network described above. For instance, the network unit 900 may correspond to or may be located in any of the network system nodes described above. The network unit 900 may also be configured to implement or support the schemes and methods described above. The network unit 900 may comprise one or more ingress ports or units 910 coupled to a receiver (Rx) 920 for receiving signals and frames/data packets from other network components. The network unit 900 also may comprise a processor 930 to determine which network components to send content to. The processor 930 may be implemented using hardware, software, or both. The network unit 900 may also comprise one or more egress ports or units 940 coupled to a transmitter (Tx) 950 for transmitting signals and frames/data packets to the other network components. The receiver 920, processor 930, and transmitter 950 may also be configured to implement at least some of the disclosed schemes and methods above, which may be based on hardware, software, or both. The components of the network unit 900 may be arranged as shown in FIG. 9 or arranged in any other configuration.

The processor 930 may also comprise a programmable content forwarding data plane block 938 and one or more storage blocks 932 that may be coupled to the programmable content forwarding data plane block 938. The programmable content forwarding data plane block 938 may be configured to implement content forwarding and processing functions as described herein, such as at an application layer where the content may be forwarded based on content name or prefix and possibly other content related information that maps the content to network traffic. Such mapping information may be maintained in one or more content tables (e.g., CS, PIT, and FIB) at the processor 930 or the network unit 900. The programmable content forwarding data plane block 938 may interpret user requests for content and accordingly fetch content, e.g., based on meta-data or content name (prefix), from the network or other content routers and may store the content, e.g., temporarily, in the storage blocks 932. The programmable content forwarding data plane block 938 may then forward the cached content to the user. The programmable content forwarding data plane block 938 may be implemented using software, hardware, or both and may operate above the IP layer.

The storage blocks 932 may comprise a cache 934 for temporarily storing content, such as content that is requested by a subscriber. Additionally, the storage blocks 932 may comprise a long-term storage 936 for storing content relatively longer, such as content submitted by a publisher. For instance, the cache 934 and the long-term storage 936 may include dynamic random-access memories (DRAMs), solid-state drives (SSDs), hard disks, or combinations thereof.

In a sample implementation of the processor 930, the network verification described herein can be performed by means of receiver 920, processor 930 including programmable content forwarding data plane block 938 and one or more storage blocks 932 and transmitter 950 that together process signals and frame/data packets as described above where the signals and frame/data are indicative of IP address and namespace, a request, or content.

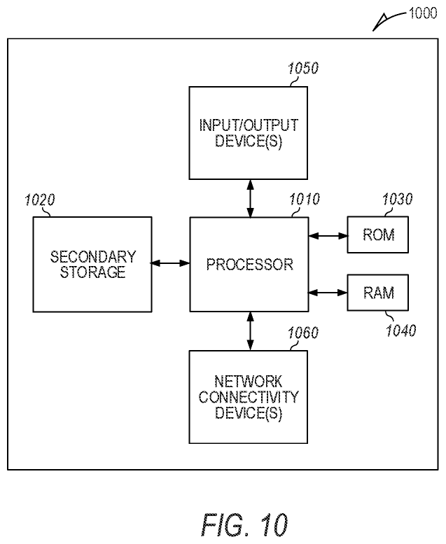

FIG. 10 illustrates a general-purpose network component 1000 suitable for implementing one or more embodiments of the components disclosed herein. The network components described above may be implemented on any general-purpose network component, such as a computer or network component 1000 with sufficient processing power, memory resources, and network throughput capability to handle the necessary workload placed upon it. The network component 1000 includes a processor 1010 (which may be referred to as a central processor unit or CPU) that is in communication with memory devices including secondary storage 1020, read only memory (ROM) 1030, random access memory (RAM) 1040, input/output (I/O) devices 1050, and network connectivity devices 1060. The processor 1010 may be implemented as one or more CPU chips, or may be part of one or more application specific integrated circuits (ASICs).

The secondary storage 1020 is typically comprised of one or more disk drives or tape drives and is used for non-volatile storage of data and as an over-flow data storage device if RAM 1040 is not large enough to hold all working data. Secondary storage 1020 may be used to store programs that are loaded into RAM 1040 when such programs are selected for execution. The ROM 1030 is used to store instructions and perhaps data that are read during program execution. ROM 1030 is a non-volatile memory device that typically has a small memory capacity relative to the larger memory capacity of secondary storage 1020. The RAM 1040 is used to store volatile data and perhaps to store instructions. Access to both ROM 1030 and RAM 1040 is typically faster than to secondary storage 1020.

It should be understood that servers, routers, and any or all of the devices within consumer or producer domains as described herein can be configured to comprise a registration, routing and resolution logic including computer-readable non-transitory media storing computer readable instructions and one or more processors coupled to the memory, and when executing the computer readable instructions are configured to perform method steps and operations described in the disclosure with reference to FIG. 1 to FIG. 9. The computer-readable non-transitory media includes all types of computer readable media, including magnetic storage media, optical storage media, flash media and solid state storage media.

It should be further understood that software including one or more computer-executable instructions that facilitate processing and operations as described above with reference to any one or all of steps of the disclosure can be installed in and sold with one or more servers and one or more routers and one or more devices within consumer or producer domains consistent with the disclosure. Alternatively, the software can be obtained and loaded into one or more servers or one or more routers or one or more devices within consumer or producer domains consistent with the disclosure, including obtaining the software through a physical medium or a distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components set forth in the following description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the systems and methods described herein can be easily construed as within the scope of the disclosure by programmers skilled in the art to which the present disclosure pertains. Method steps associated with the illustrative embodiments can be performed by one or more programmable processors executing a computer program, code or instructions to perform functions (e.g., by operating on input data and generating an output). Method steps can also be performed by, and apparatus can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, CD-ROM disks, or DVD-ROM disks). The processor and the memory can be supplemented by, or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art may further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. A software module may reside in random access memory (RAM), flash memory, ROM, EPROM, EEPROM, registers, hard disk, a removable disk, a CD-ROM, or any other form of storage medium known in the art. A sample storage medium is coupled to the processor such the processor can read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A network verification system, comprising:
a non-transitory memory storing instructions; and
at least one processor in communication with the memory, the at least one processor configured, upon execution of the instructions, to perform the following steps:
process a network forwarding state into atomic predicates;
compress a network routing table into an atomic predicates indexes set;
calculate a transitive closure among all pairs of nodes in the network from the atomic predicates and atomic predicates indexes set to generate an all-pair reachability matrix Mₙ of the network;
recursively generate for respective nodes a reachability report for the network based on the all-pair reachability matrix Mₙ; and
dynamically program the network using the reachability report.

2. The system of claim 1, the at least one processor further executing the instructions to calculate the transitive closure among the all pairs of nodes in the network by modeling a network routing table into a routing matrix comprising the all-pair reachability matrix Mₙ.

3. The system of claim 1, the at least one processor further executing the instructions to:
calculate the all-pair reachability matrix Mₙ of the network by calculating, for each pair of nodes in the network, whether there is any packet that may travel from one node to another node of the pair of nodes; and
collecting packet headers from all possible paths between the pair of nodes.

4. The system of claim 1, wherein an element R^{k}ᵢⱼ in the all-pair reachability matrix Mₙ includes a reachability packet space set between node i and node j, where k is an intermediate node, further comprising the at least one processor executing the instructions to calculate the element R^{k}ᵢⱼ as:
R^{k}[i,j]=R^{k-1}[i,j]∪(R^{k-1}[i,k]∩R^{k-1}[k,j]).

5. The system of claim 1, the at least one processor further executing the instructions to identify a loop in the network when any element on a diagonal of the all-pair reachability matrix Mₙ is not an empty set.

6. The system as in claim 1, the at least one processor further executing the instructions to identify a black hole in the network when all elements in a row of the all-pair reachability matrix Mₙ comprise an empty set.

7. The system of claim 1, the at least one processor further executing the instructions to update the generated all-pair reachability matrix Mₙ by recalculating only elements affected by an update.

8. The system of claim 1, the at least one processor further executing the instructions to calculate the all-pair reachability matrix Mₙ without performing a reachability matrix calculation for non-intermediate nodes in the network.

9. The system of claim 1, the at least one processor further executing the instructions to calculate the all-pair reachability matrix Mₙ by performing the reachability matrix calculation for first nodes with frequent updates after performing the reachability matrix calculation for second nodes without frequent updates.

10. The system of claim 1, the at least one processor further executing the instructions to calculate the all-pair reachability matrix Mₙ based on matrices of nodes.

11. A computer implemented method of verifying a state of a network comprising a plurality of nodes, the method comprising:
processing a network forwarding state into atomic predicates;
compressing a network routing table into an atomic predicates indexes set;
calculating a transitive closure among all pairs of nodes in the network from the atomic predicates and atomic predicates indexes set to generate an all-pair reachability matrix Mₙ of the network;
recursively generating for respective nodes a reachability report for the network based on the all-pair reachability matrix Mₙ; and
dynamically programming the network using the reachability report.

12. The method of claim 11, wherein the calculating the transitive closure among the all pairs of nodes in the network comprises modeling a network routing table into a routing matrix comprising the all-pair reachability matrix Mₙ.

13. The method of claim 11, wherein calculating the all-pair reachability matrix Mₙ comprises:
calculating, for each pair of nodes in the network, whether there is any packet that may travel from one node to another node of the pair of nodes; and
collecting packet headers from all possible paths between the pair of nodes.

14. The method of claim 11, wherein an element R^{k}ᵢⱼ in the all-pair reachability matrix Mₙ includes a reachability packet space set between node i and node j, where k is an intermediate node, further comprising calculating the element R^{k}ᵢⱼ as:
R^{k}[i,j]=R^{k-1}[i,j]∪(R^{k-1}[i,k]∩R^{k-1}[k,j]).

15. The method of claim 11, further comprising identifying a loop in the network when any element on a diagonal of the all-pair reachability matrix Mₙ is not an empty set.

16. The method of claim 11, further comprising identifying a black hole in the network when all elements in a row of the all-pair reachability matrix Mₙ comprise an empty set.

17. The method of claim 11, further comprising updating the all-pair reachability matrix Mₙ by recalculating only elements affected by an update.

18. The method of claim 11, wherein the calculating the all-pair reachability matrix Mₙ comprises calculating the all-pair reachability matrix Mₙ without performing a reachability matrix calculation for non-intermediate nodes in the network.

19. The method of claim 11, wherein calculating the all-pair reachability matrix Mₙ comprises performing the reachability matrix calculation for first nodes with frequent updates after performing the reachability matrix calculation for second nodes without frequent updates.

20. A computer-readable medium storing computer instructions implementing verification of a state of a network comprising a plurality of nodes, that when executed by at least one processor, causes the at least one processor to perform operations comprising:
processing a network forwarding state into atomic predicates;
compressing a network routing table into an atomic predicates indexes set;
calculating a transitive closure among all pairs of nodes in the network from the atomic predicates and atomic predicates indexes set to generate an all-pair reachability matrix Mₙ of the network;
recursively generating for respective nodes a reachability report for the network based on the all-pair reachability matrix Mₙ; and
dynamically programming the network using the reachability report.
